(19) United States
(12) Patent Application Publication
(10) Pub. No.: US 2013/0058736 A1
(43) Pub. Date: Mar. 7, 2013

(54) Drivable eye bolt

(71) Applicant: Jed Auchey, Hanover, PA (US)

(72) Inventor: Jed Auchey, Hanover, PA (US)

(21) Appl. No.: 13/199,572

(22) Filed: Sep. 2, 2011

(51) Int. Cl. F16B 25/10; F16B 23/00

(52) U.S. Cl. 411/387.4; 411/402; 411/403

(57) ABSTRACT

An eye bolt has an elongate threaded shank having a longitudinal axis and a loop projection, such as a circular loop, extending from one end of the shank and a driving head rigidly mounted on the loop projection coaxially with the axis. To facilitate insertion into a material, the shank may include a self drilling and self tapping portion at the opposite end portion of the shank. A rotational driving force applied to the driving head causes the self drilling and self tapping portion to drill a hole in the material into which the threaded portion on the shank is screwed.

### FIELD OF THE INVENTION

The present invention relates to eye bolts and, more particularly, to eye bolts which are simple to start without need for a pilot hole and drivable without need for special tools or attachments.

### BACKGROUND OF THE INVENTION

Eye bolts with lag threads are commonly used to hang loads from overhead locations, such as beams and ceilings, as well as from walls, trees and other structures. In the usual procedure, the worker will either hammer the eye bolt into the structure (e.g., wood) in order to grab a few threads, or he will pre-drill a pilot hole. In either case the threaded shank of the eye bolt is thereafter manually screwed into the structure material using conventional tools such as wrenches or pliers to grasp the loop of the eye bolt or by insertion of a short bar through the eye of the bolt. The bar is then operated to rotate the eye bolt until the bolt is securely in place. Any type of short bar which fits through the loop of the bolt is satisfactory and, frequently, the shaft of a screwdriver is used as the bar. However, use of a bar for rotating the eye bolt is slow and clumsy, particularly if a large number of eye bolts are to be inserted in place. Special tools have been devised to assist in rotating the eye bolt, such as rotatable driver attachments which are configured to grasp and rotate the loop of the eye bolt. For example, U.S. Pat. No. 5,628,235 to Kambara discloses a portable drill attachment comprising separately adjustable jaws. U.S. Pat. No. 6,374,707 to Browning discloses a wrench comprising a shaft adapted to be driven by an electrically powered rotational driving device and an eye bolt cup having a cavity for snugly receiving the eye portion of an eye bolt. However, such special tools are expensive to acquire and, typically, not readily available.

It will be appreciated that the procedure for threading an eye bolt into a structure is cumbersome, time consuming and requires several different tools. Moreover, unless a pilot hole is first drilled, the starting process can be frustrating and difficult since hammering is likely to deform the loop end of the eye bolt. Of course, drilling the pilot hole requires additional time and additional tools. Accordingly, there exists a need for an eye bolt which can be easily started without need for a separately drilled pilot hole and which can be rapidly and simply inserted into a structure utilizing a single readily available tool.

### SUMMARY OF THE INVENTION

It is, therefore, a primary object of the present invention to provide a novel and improved eye bolt which is simple to insert into a structure without need for special tools.

It is also an object of the present invention to provide a novel and improved eye bolt which is simple to start without need for a pilot hole and which can be rapidly inserted utilizing a single readily available tool.

It is another object of the present invention to provide a novel and improved eye bolt which includes a driving head to facilitate being driven by a tool capable of engaging the driving head and rotating the eye bolt about the axis of the shank.

It is yet another object of the present invention to provide a novel and improved eye bolt which is self drilling and self tapping.

The foregoing and other objects are achieved in accordance with the present invention by providing an eye bolt for insertion into a material comprising:

an elongate shank having a longitudinal axis and a loop projection extending from one end of said shank;

said shank having a threaded portion extending from the opposite end of said shank along at least a portion of its length; and

a driving head rigidly mounted on said loop projection, said driving head being coaxial with the longitudinal axis of said shank, whereby a rotational driving force applied to said driving head causes said threaded portion on said shank to screw into said material to securely insert said eye bolt into said material.

In another aspect of the invention, there is provided an eye bolt wherein the loop projection is either a fully closed loop, such as a circular loop, or a partially closed loop.

In yet another aspect of the invention there is provided an eye bolt wherein said driving head is polygonal for defining a plurality of flats, and/or said driving head includes a surface defining sockets or slots, which can be engaged by a rotatable driving tool.

In still another aspect of the invention there is provided an eye bolt for insertion into a material comprising:

an elongate shank having a longitudinal axis, a loop projection extending from one end of said shank and a self drilling and self tapping portion at the opposite end portion of said shank;

said shank having a first threaded portion along at least a portion of its length which is contiguous with said self drilling and self tapping portion; and

a driving head rigidly mounted on said loop projection, said driving head being coaxial with the longitudinal axis of said shank, whereby a rotational driving force applied to said driving head causes said self drilling and self tapping portion to drill an internally threaded hole in said material into which said threaded portion on said shank may be screwed to securely insert said eye bolt into said material.

In yet another aspect of the invention there is provided an eye bolt wherein said self drilling and self tapping end portion of said shank includes a second threaded portion along its length and a drilling tip at its free end, said drilling tip including cutting edges for drilling a core hole in the material.

In a preferred aspect of the invention said first threaded portion has a larger diameter than said second threaded portion and said self drilling and self tapping end portion includes a tapered threaded shank portion interconnecting the first and second threaded portions.

### BRIEF DESCRIPTION OF THE DRAWINGS

FIG. 1 is a perspective view of one embodiment of the eye bolt of the present invention.

FIG. 2 is a top plan view of the eye bolt of FIG. 1.

FIG. 3 is a perspective view of the lower shank end portion showing an illustrative self-tapping configuration.

FIG. 4 is a perspective view of another embodiment of the eye bolt of the present invention.

FIG. 5 is a perspective view of still another embodiment of the eye bolt of the present invention.

### DETAILED DESCRIPTION OF THE INVENTION

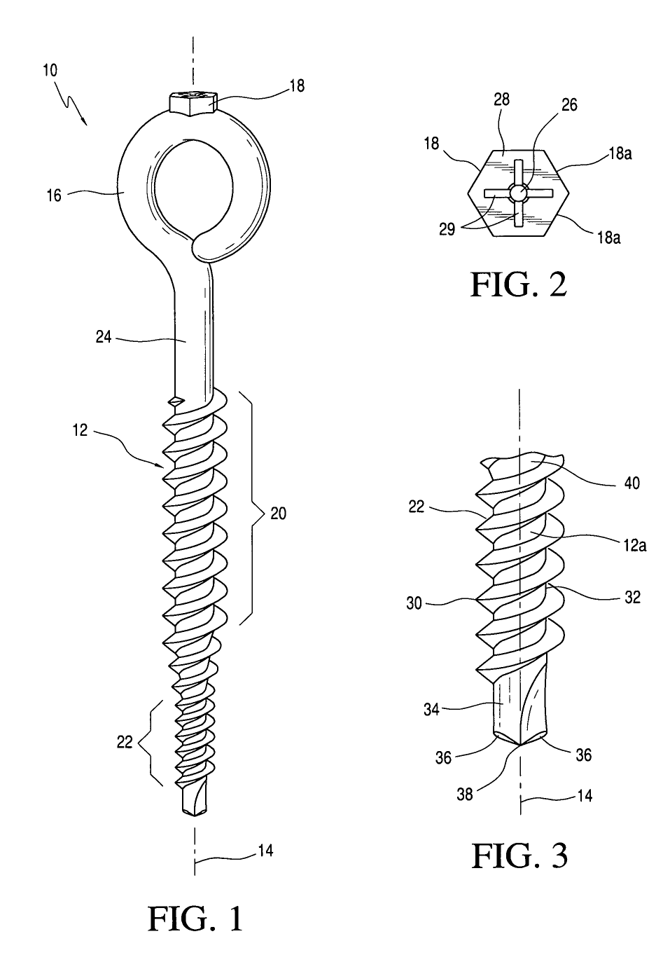

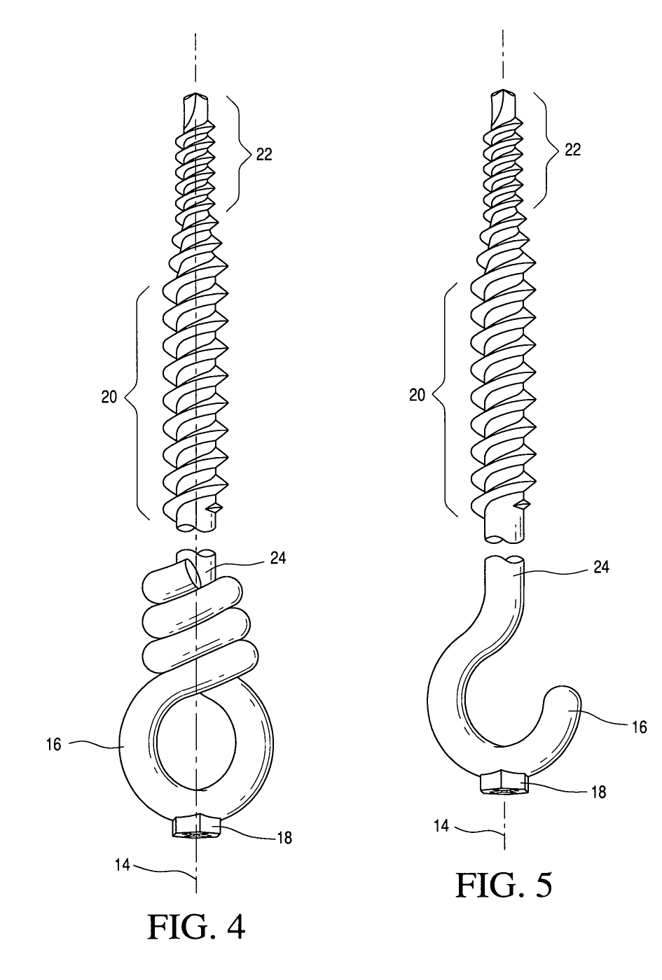

Referring to FIG. 1, there is shown one embodiment of the eye-bolt of the present invention. Eye bolt 10 includes a shank 12 having a longitudinal axis 14, a loop portion 16, a driving head 18 mounted, e.g., by welding, forging, on loop portion 16 remote from shank 12 and coaxial with shank 12 and a threaded portion 20 along shank 12. In one form of the invention, shank 12 is provided with a self drilling and self tapping portion 22 at the end of shank 12 remote from loop portion 16. Shank 12 may be completely threaded along its length between self drilling and tapping portion 22 and loop portion 16 or threaded portion 18 may terminate short of loop portion 16 for defining a smooth shank portion 24 between the end of threaded portion 20 and loop portion 16. Threaded portion 20 of shank 12 may have a substantially cylindrical external diameter or its diameter may gradually taper downwardly toward a smaller diameter or a point at its end remote from loop portion 16. Loop portion 16 may define a closed loop as illustrated in FIGS. 1 and 4 or may define only a partial loop as illustrated in FIG. 5. As used herein the term “loop” is intended broadly to mean a curved portion of the bolt extending from shank 12.

Referring to FIGS. 1 and 2, driving head 18 is desirably a head of any suitable configuration, preferably polygonal, to define a plurality of external flats 18a around the head which may be easily grasped by a bolt driving tool, such as a wrench. Driving head 18 also desirably includes a recess 26 in its upper surface 28 which defines sockets or slots for receiving manually operated or power driven rotary tools, such as screwdrivers, therein. Accordingly, upper surface 28 may include one or more screw drives 29 such as, but not limited to, flat slotted, Phillips, hex, Robertson (square), torx (star), as well as any other screw drives.

Referring to FIG. 3, self drilling and self tapping portion 22 has an elongate shank portion 12a which is arranged coaxially with the longitudinal axis 14 of shank 12 to define a drilling axis. Shank portion 12a is provided with male screw threads 30 having forming grooves 32 and a drilling tip 34 at the free end of shank 12a. Drilling tip 34 desirably includes at least two cutting edges 36 which, in one embodiment, may lie in a longitudinal plane, extend radially from the central boring tip 38 and be arranged symmetrically about the longitudinal axis 14. Cutting edges 36 make it possible to drill a core hole in the structure material and, as the screw threads 30 of shank 12a are screwed into this core hole, create a counterpart internally threaded hole for receiving larger diameter threaded portion 20 of shank 12, which are screwed into the internally threaded hole to rigidly hold the eye bolt 10 in place in the material. To facilitate the transition from the larger diameter threaded portion 20 to the smaller diameter screw threads 30 of shank portion 12a, shank portion 12a includes a tapered threaded shank portion 40 at its upper end where it merges with threaded portion 20. It will be appreciated that the self drilling and self tapping portion 22 need not be limited to the drilling tip configuration described hereinabove, but may comprise any suitable self drilling and self tapping configuration known to the prior art which is suitable for the structural material into which it is drilled and is appropriate for the intended usage of the eye bolt and the dimensions of the eye bolt threaded portion 20.

In use, the eye bolt 10 is positioned for insertion into structural material with its boring tip 38 pressed against the insertion location. A rotatable tool is selected which is able to rotatably drive head 18. For example, such a tool might be a hand operated wrench, a socket wrench, a screwdriver or a power driven rotary tool having a driving element compatible with the grooves and/or sockets and/or flats of drive head 18. The positioning of drive head 18 coaxially with shank 12 allows rotation of the rotatable tool to rotate shank 12. Initially, the cutting edges 36 of drilling tip 34 drill a core hole in the material and, as tool rotation continues, the screw threads 30 of shank 12a are screwed into this core hole, creating an internally threaded hole for receiving larger diameter threaded portion 20 of shank 12. Tapered threaded shank portion 40 facilitates the transition between, and interconnects, screw threads 30 and the larger diameter threads of threaded portion 20 which, guided by the internally threaded hole, bite into the material until eye bolt 10 is fully screwed into the material.

While the present invention has been described in terms of specific embodiments thereof, it will be understood that no limitations are intended to the details of construction or design other than as defined in the appended claims.

1. An eye bolt for insertion into a material comprising:
an elongate shank having a longitudinal axis and a loop projection extending from one end of said shank;
said shank having a first threaded portion extending from the opposite end of said shank along at least a portion of its length; and
a driving head rigidly mounted on said loop projection, said driving head being coaxial with the longitudinal axis of said shank, whereby a rotational driving force applied to said driving head causes said threaded portion on said shank to screw into said material to securely insert said eye bolt.

2. An eye bolt, as claimed in claim 1, wherein said loop projection defines a closed loop projection, the center of which is coaxial with the longitudinal axis of said shank.

3. An eye bolt, as claimed in claim 2, wherein said closed loop projection is circular.

4. An eye bolt, as claimed in claim 3, wherein said driving head is mounted on said circular projection at a position coaxial with and remote from said shank.

5. An eye bolt, as claimed in claim 1, wherein said driving head is polygonal for defining a plurality of flats which can be grasped by a rotatable driving tool.

6. An eye bolt, as claimed in claim 1, wherein said driving head includes a surface defining sockets or slots for receiving rotatable driving tools.

7. An eye bolt, as claimed in claim 6, wherein said surface defining sockets or slots is a surface of said driving head remote from said shaft.

8. An eye bolt, as claimed in claim 1, wherein said loop projection defines a partially closed loop projection.

9. An eye bolt, as claimed in claim 8, wherein the center of the partially closed loop projection is coaxial with the longitudinal axis of said shank.

10. An eye bolt, as claimed in claim 1, further including a self drilling and self tapping portion at the opposite end portion of said shank, said shank having a first threaded portion along at least a portion of its length which is contiguous with said self drilling and self tapping portion and extends toward said loop portion, whereby a rotational driving force applied to said driving head causes said self drilling and self tapping portion to drill a hole in said material into which said first threaded portion on said shank is screwed to securely insert said eye bolt into said material.

11. An eye bolt, as claimed in claim 10, wherein said loop projection defines a closed loop projection, the center of which is coaxial with the longitudinal axis of said shank.

12. An eye bolt, as claimed in claim 11, wherein said closed loop projection is circular.

13. An eye bolt, as claimed in claim 12, wherein said driving head is mounted on said circular projection at a position coaxial with and remote from said shank.

14. An eye bolt, as claimed in claim 10, wherein said driving head is polygonal for defining a plurality of flats which can be grasped by a rotatable driving tool.

15. An eye bolt, as claimed in claim 10, wherein said driving head includes a surface defining sockets or slots for receiving rotatable driving tools.

16. An eye bolt, as claimed in claim 10 wherein said self drilling and self tapping end portion of said shank includes a second threaded portion along its length and a drilling tip at its free end, said drilling tip including cutting edges for drilling a core hole in the material.

17. An eye bolt, as claimed in claim 16, wherein said first threaded portion has a larger diameter than said second threaded portion and said self drilling and self tapping end portion includes a threaded tapered shank portion interconnecting the first and second threaded portions.

18. An eye bolt, as claimed in claim 15, wherein said surface defining sockets or slots is a surface of said driving head remote from said self drilling and self tapping portion.

19. An eye bolt, as claimed in claim 10, wherein said loop projection defines a partially closed loop projection.

20. An eye bolt, as claimed in claim 19, wherein the center of the partially closed loop projection is coaxial with the longitudinal axis of said shank.
